(19) United States
(12) Patent Application Publication
(10) Pub. No.: US 2025/0126687 A1
(43) Pub. Date: Apr. 17, 2025

(54) Core Temperature Detector and Combination Cooking Appliance Having a Core Temperature Detector

(71) Applicant: RATIONAL Aktiengesellschaft, Landsberg am Lech (DE)

(72) Inventors: Christian KOENEN, Landsberg am Lech (DE); Peter SELIG, Landsberg am Lech (DE)

(21) Appl. No.: 18/915,657

(22) Filed: Oct. 15, 2024

(30) Foreign Application Priority Data
Oct. 12, 2023 (DE) 10 2023 127 961.0

(51) Int. Cl. H05B 6/64; G01K 1/08; G01K 1/14

(52) U.S. Cl. CPC H05B 6/6452; G01K 1/08; G01K 1/14; H05B 6/6479

(57) ABSTRACT

A core temperature detector for a combination cooking appliance, has a measuring section and a handle section. Furthermore, a contacting tube is provided, a cable being guided in the contacting tube. The cable has an unsheathed area in the handle section, in which the contacting tube forms a contact point along with the cable, wherein the contact point has a distance to the handle-side end, which corresponds to an electrical length of the microwave radiation in the handle section, which is shorter than or equal to one quarter of the wavelength of the microwave radiation used in the combination cooking appliance. Also described is a combination cooking appliance comprising the core temperature detector as above described.

### BACKGROUND OF THE INVENTION

The invention relates to a core temperature detector having a microwave trap and to a cooking appliance having a core temperature detector.

In professional or canteen kitchens, combination cooking appliances are used which can cook a cooking product in a cooking chamber of the combination cooking appliance in different ways. In addition to the classic cooking methods which use hot air and/or steam, modern combination cooking appliances often also use microwave radiation. To cook the cooking product, the energy of microwave radiation can be used alone or in combination with the aforementioned methods. Magnetrons or semiconductor components can be used as microwave sources to feed microwaves into the cooking chamber.

To achieve the best possible results when cooking a cooking product, it is advantageous to monitor the cooking process as precisely as possible to modify certain cooking parameters such as the temperature, the air humidity and/or the cooking time if necessary.

In modern cooking appliances, core temperature detectors, among other things, are used for this purpose. A core temperature detector typically comprises a measuring rod equipped with temperature sensors, which is inserted into the cooking product before the cooking process begins. During the cooking process, the temperature sensors measure the core temperatures in the core of the cooking product and transmit these to an evaluation unit of the cooking appliance. The measured core temperatures make it possible to determine the degree of cooking of the cooking product, so that the cooking process can be regulated on the basis of this information to achieve the desired cooking result.

In microwave operation, the use of the core temperature detector poses the problem that the measuring rod may act as an antenna which receives the microwaves that are fed in. This leads to unwanted electrical currents within the core temperature detector, which may cause a temperature increase in the core temperature detector. This may cause the core temperature detector to heat up so much that the core temperature detector is damaged. This may occur in particular when the core temperature detector is in a park position, i.e. is not inserted into the cooking product.

If the core temperature detector is inserted into the cooking product, the cooking product can be heated above average in the area of the measuring rod. The measured temperatures can also be falsified by the unwanted heating of the core temperature detector, in particular the temperature sensors.

### SUMMARY OF THE INVENTION

In this respect, the object of the present invention is to provide a device to prevent damage to the core temperature detector, unwanted heating of the cooking product and faulty measurements when the microwave operation in a combination cooking appliance is switched on.

According to the invention, the object is achieved by a core temperature detector for a combination cooking appliance for cooking a cooking product, comprising a measuring section and a handle section. Furthermore, a contacting tube is provided which extends at least partially into the handle section and has a handle-side end facing the handle section. A cable extending from the handle section into the measuring section is guided in the contacting tube. The cable has an unsheathed area in the handle section, in which the contacting tube forms a contact point along with the cable. The contact point has a distance to the handle-side end, which corresponds to an electrical length of the microwave radiation in the handle section, which is shorter than or equal to one quarter of the wavelength of the microwave radiation used in the combination cooking appliance.

This ensures that the handle-side end of the contacting tube is located in a minimum of the electromagnetic field (hereinafter referred to as E-field) generated by the microwave radiation during microwave operation of the combination cooking appliance, i.e. at a position in the electromagnetic field in which the field strength has a local or a global minimum. This reduces the current flow in the handle-side end at this position, thus reducing the overall energy input into the core temperature detector. A lower energy input in turn causes the core temperature detector, in particular the handle section, to heat up less, as a result of which the durability of the handle is extended in a simple way. As the service life of a core temperature detector is largely determined by the durability of the handle section, the core temperature detector overall has an improved service life.

A contacting tube is a tubular element having the shape of an elongated, hollow cylindrical body so that a cable can be received and guided therein. In particular, the contacting tube is a circular cylinder, i.e. it has a circular cross-section.

A handle-side end is understood to mean the end of the contacting tube which faces the handle section, i.e. away from the measuring section. Accordingly, the contact point is arranged in the direction of the measuring section as seen from the handle-side end.

A “measuring section” refers to the area used to measure the temperature inside a cooking product when inserted. For example, at least one temperature sensor may be provided in the measuring section for this purpose. The measuring section does not have to be fully inserted into the cooking product for this purpose. The measuring section is also referred to as a measuring rod.

The term “handle section” refers to the area of the core temperature detector at which the core temperature detector can be held by a user. To this end, the handle section may for example have a shape which is ergonomically adapted to the hand so that the core temperature detector can be easily handled in the cooking chamber.

Wavelength refers in particular to the wavelength in a vacuum (or approximately in air).

The electrical length is understood to be the distance traveled by an electromagnetic wave in a propagation medium, e.g. in the handle section and/or in the measuring section. This is particularly the case when the field lines are completely within the material, e.g. in a coaxial structure, in particular between a braided shielding and the contacting tube.

Due to the dielectric properties of the materials arranged in the two sections, the electrical length may differ from the length or distance that the electromagnetic wave would travel in a vacuum (in the same time), which is also referred to as the mechanical length. In other words, the electrical length is smaller than or at most equal to the distance in a vacuum, depending on the permittivity and, if applicable, the permeability of the propagation medium. Mathematically, the relationship can be expressed as follows:

$${l}_{e l} = {l}_{m e c h} \cdot \sqrt{{μ}_{r} {ε}_{r}} ,$$

lₑₗ being the electrical length, l_{mech} being the mechanical length, μᵣ being the relative permeability number and εᵣ being the relative permittivity, which corresponds to the dielectric. The product of the relative permeability number μᵣ and the relative permittivity εᵣ is greater than 1 for common materials. In a vacuum, the product is exactly 1, whereas in air it is approximately 1.

In particular, a volume (field strength)-weighted relative permittivity εᵣ and a volume (field strength)-weighted relative permeability number μᵣ can be used for the handle section of the core temperature detector. The field lines are only partially present in the handle or measuring section, as another part is present in the air.

The handle section, i.e. all materials arranged therein, corresponds to the electrical length of the microwave radiation in the handle section, which means that the electromagnetic waves of the microwave radiation, i.e. the microwaves, in the handle section have an electrical length which corresponds at least to one quarter of the wavelength of the microwave radiation. Depending on the material in the handle section, the distance between the contact point and the handle-side end is shorter than the electrical length. The greater the relative permeability number of the material used in the handle section, the shorter the distance can be to still ensure that the electrical length of the microwave radiation in the handle section is less than a quarter of the wavelength of the microwave radiation (in a vacuum). This is due to the influence of permeability and permittivity, as explained above.

In this respect, the electrical length can be understood as the distance traveled in a vacuum with a velocity factor. The velocity factor arises from the fact that the electromagnetic wave, i.e. the microwave, propagates in a propagation medium with a different permittivity (and permeability) than vacuum, for example in the material in the handle section. The handle section represents a dielectric for the electromagnetic radiation entering it. This physical relationship is expressed by the velocity factor, which depends on the propagation medium and is “1” in the case of a vacuum.

As a result, the distance between the contact point and the handle-side end may be shorter, namely by the velocity factor, provided that the material (propagation medium) in the handle section, in particular inside the groove, is different from that in the cooking chamber, e.g. the material of the handle, the contacting tube, the cable or other components in the handle section.

In this respect, the following relationship generally applies:

$$\frac{1}{4} λ \cdot {F}_{h a ndle section} \leq {d}_{d i s t a n c e}$$

λ corresponding to the wavelength of the microwave radiation used in the cooking chamber (in a vacuum) and d_{distance} being the distance between the contact point and the handle-side end, and F_{handle section} being the velocity factor of the handle section, wherein the velocity factor can be expressed by

$$\frac{1}{\sqrt{{μ}_{r} {ε}_{r}}} .$$

To ensure a particularly low energy input into the handle section, it is preferred that the electrical length is at least 0.1 cm shorter than a quarter of the wavelength of the microwave radiation used in the combination cooking appliance. Particularly preferably, the electrical length is at least 0.5 cm shorter than a quarter of the wavelength of the microwave radiation used in the combination cooking appliance. Particularly preferably, the electrical length is at least 1.5 cm shorter than a quarter of the wavelength of the microwave radiation used in the combination cooking appliance.

According to a first aspect of the invention, it is provided that the core temperature detector is provided with a microwave trap having a top-shaped trap section which has a trap opening aligned with the measuring section and a bottom provided with a central passage in the direction of the handle section. The contacting tube extends through the central passage.

“Pot-shaped trap section” refers to the area of the microwave trap which captures electromagnetic waves in the microwave range. To this end, it has a geometric depth, as measured from the bottom to the opening, which is specific to at least one electrical length of the electromagnetic radiation used in the cooking chamber, to trap it in the trap section.

A microwave trap refers to a quarter-wave trap. A quarter-wave trap is an assembly which prevents microwave rays from passing through the assembly. Basically, the microwave trap can be designed as desired, as long as it has a geometric depth which corresponds to an electrical length of approximately one quarter of the wavelength of the microwave radiation used in the cooking chamber. The quarter-wave trap may further comprise a dielectric, the geometric depth is shorter than a quarter of the wavelength, wherein the quarter-wave trap still has an electrical length corresponding to a quarter of the wavelength.

Furthermore, the microwave trap also works synergistically with the arrangement of the contact point and the handle-side end, since the microwave trap reduces the microwave radiation entering the handle section as a whole, and the distance between the contact point and the handle-side end further reduces the energy input of the remaining microwave radiation into the handle section.

In particular, the contacting tube is in contact with the bottom at the central passage, wherein the contacting tube is preferably laser-welded to the bottom at the central passage. This is a particularly efficient manufacturing method for a microwave trap.

According to a further aspect, the contacting tube contacts a shielding of the cable in an electrically conductive manner at the contact point. Consequently, according to this aspect, the contacting tube is made of an electrically conductive material, the contacting tube being preferably made of a metallic material. Due to the electrically conductive properties, the contacting tube can absorb electrical currents and transmit them via the contact point to the unsheathed area of the cable.

Preferably, the shielding is a braided shielding. A braided shielding is a proven way of protecting the inside of the cable from electromagnetic interference.

In a further embodiment of the invention, the handle-side end of the contacting tube is arranged in an insulated area of the cable in which the shielding is surrounded by an outer line sheath.

In this respect, the handle-side end forms the transition from the contacting tube to the outer line sheath of the cable. In particular, the handle-side end is crimped onto the outer line sheath of the cable, the cable and the end of the contacting tube being thus firmly connected to each other. On the one hand, the arrangement of the handle-side end on the outer line sheath is advantageous to introduce a current generated along the contacting tube not via any points into the shielding, but only into the unsheathed area, the currents introduced into the cable being thus defined. On the other hand, the penetration of liquid and air humidity is prevented.

The outer line sheath is preferably made of an electrically non-conductive material, such as PTFE.

A further aspect of the invention provides that a counterpressure element is arranged in the unsheathed area below the shielding, which is designed to exert a radially outwardly directed force on the shielding so that it is pressed outwardly against the contacting tube.

The counterpressure element may be a sleeve or similar. The only requirement is that the counterpressure element has the shape of a hollow-cylindrical body so that it can accommodate the interior of the cable.

Preferably, the counterpressure element has a diameter which is equal to or greater than the diameter of the shielding, so that when the shielding is put over the counterpressure element, the counterpressure element is pressed radially outwards by the equal or greater diameter of the counterpressure element.

Alternatively, a pressure element may be arranged in the unsheathed area above the shielding, via which the contact point is formed which (indirectly) connects the cable, in particular the shielding thereof, to the contacting tube. In other words, the contacting tube forms an (indirect) contact point with the cable, namely in the unsheathed area.

The pressure element may be crimped to the shielding and rolled with the contacting tube. To provide counterpressure for rolling on the contacting tube, the pressure element may include a section having a larger diameter than the rest of the pressure element.

In this respect, the contacting tube is indirectly connected to the cable via the pressure element.

In principle, the contact point establishes an electrical contact between the cable and the contacting tube. The electrical contact may be indirect, namely via the pressure element, or direct, provided that the contacting tube directly contacts a part of the cable, e.g. the shielding thereof. The counterpressure element may then be provided, which is arranged below the shielding.

However, for the contacting tube, the pressure element may also constitute the counterpressure element. This is because the pressure element is applied to the cable, in particular to the shielding thereof, but acts as the counterpressure element for the contacting tube when the latter is rolled.

A further embodiment of the invention involves that the contacting tube substantially completely touches the shielding at the contact point along the circumference of the shielding, so that the contact point is formed as a continuous contact ring. Alternatively, the contacting tube can substantially completely touch the pressure element at the contact point along the circumference of the pressure element, so that the contact point is formed as a continuous contact ring.

This ensures a particularly good contacting. In addition, a continuous contacting in the form of a contact ring provides a particularly stable connection between the contacting tube and the shielding or the pressure element.

According to a further aspect of the invention, the contact point is formed by a radially inwardly directed bulge of the contacting tube, wherein the bulge is produced in particular by rolling the contacting tube onto the cable.

The inwardly directed bulge refers to a radially inwardly pointing recess along the circumference of the contacting tube, which touches the shielding at least with its vertex and thus makes an electrically conductive contact therewith. A bulge is easy to manufacture and thus represents a simple design to establish a contact between the contacting tube and the shielding. Furthermore, the bulge reduces the diameter of the contacting tube and presses on the shielding, so that the shielding and thus also the cable are held securely against slipping on the bulge.

A further aspect of the invention provides that the contact point is arranged at a minimum distance from the bottom.

According to the invention, the distance between the contact point and the handle-side end corresponds to a distance which corresponds to an electrical length of the microwave radiation in the handle section, which is equal to or less than one quarter of the wavelength of the microwave radiation used in the combination cooking appliance. This condition can be realized particularly easily by placing the contact point as close as possible to the bottom of the microwave trap. The term minimum distance thus refers to the technically smallest possible distance at which the bottom may be spaced apart from the contact point without the bottom being deformed by the introduction of the contact point between the contacting tube and the shielding, which would negatively affect the function of the microwave trap.

For example, the distance is 0.1-4 mm, preferably 0.1-2 mm, particularly preferably 0.1-1 mm.

According to a further aspect of the invention, the trap opening has a distance to the handle-side end which corresponds to an electrical length of the microwave radiation in the handle section which is shorter than or equal to one quarter of the wavelength of the microwave radiation used in the combination cooking appliance.

The distance between the trap opening and the handle-side end is measured from the center of the trap opening to the center of the handle-side end of the contacting tube, both centers having a common axis of rotation which extends from the handle section into the measuring section.

Due to the selected distance between the trap opening and the handle-side end, the transition from the contacting on the outer line sheath of the cable to is also located in a local or global minimum in the electric field in a microwave operation of the cooking appliance. Therefore, a lower field strength is coupled to the transition point and the sheath current flow is reduced. This has the advantage that less heat is generated at the handle-side end, which extends the durability of the core temperature detector.

Furthermore, the invention relates to a combination cooking appliance for cooking a cooking product, comprising a cooking chamber, a microwave generator and a control unit which is in communication with a core temperature detector according to any of the preceding aspects, which is provided in the cooking chamber. A combination cooking appliance is a cooking appliance for cooking a cooking product which, in addition to the use of microwave rays, can also cook the cooking product by means of steam and/or hot air. Such a cooking appliance allows a combination of different cooking methods, which can be used either individually or jointly.

Due to the use of a core temperature detector according to the above-mentioned aspects, the combination cooking appliance according to the invention can use the core temperature detector during microwave operation without excessively heating the handle section and/or the measuring section. Since the measuring section is not locally heated, a more accurate temperature sensing is possible, which allows the cooking appliance to monitor the cooking process more precisely. This also makes it possible to control the cooking process more accurately and achieve better cooking results. In contrast thereto, the reduced heating of the handle section enables a longer durability of the core temperature detector.

### BRIEF DESCRIPTION OF THE DRAWINGS

Further features and advantages of the invention will become apparent from the description below and from the accompanying drawings, to which reference is made and in which:

FIG. 1 shows a schematic representation of a combination cooking appliance according to the invention with a core temperature detector according to the invention;

FIG. 2 shows a schematic sectional view of the core temperature detector according to the invention of FIG. 1;

FIG. 3 shows a schematic sectional view of the handle section of the core temperature detector according to the invention of FIG. 1;

FIG. 4 shows a schematic representation of the measuring-side end of a cable for the core temperature detector according to the invention of FIG. 1;

FIG. 5 shows a schematic sectional view of the cable guiding in the handle of the core temperature detector according to the invention of FIG. 1;

FIG. 6A shows a schematic sectional view of the cable guiding in the handle of the core temperature detector according to the invention of FIG. 1, with a counterpressure element;

FIG. 6B shows a schematic sectional view of the cable guiding in the handle of the core temperature detector according to the invention of FIG. 1, with a pressure element designed as a cover sleeve;

FIG. 7 shows a simulation model for simulating the electromagnetic load along the core temperature detector according to the invention of FIG. 1;

FIG. 8 shows a simulation graphic according to the simulation model of FIG. 7 of an E-field along a core temperature detector not according to the invention;

FIG. 9 shows a diagram of the simulation graphic of FIG. 8;

FIG. 10 shows a simulation graphic according to the simulation model of FIG. 7 of an E-field along a core temperature detector according to the invention; and

FIG. 11 shows a diagram of the simulation graphic of FIG. 10.

### DETAILED DESCRIPTION OF THE INVENTION

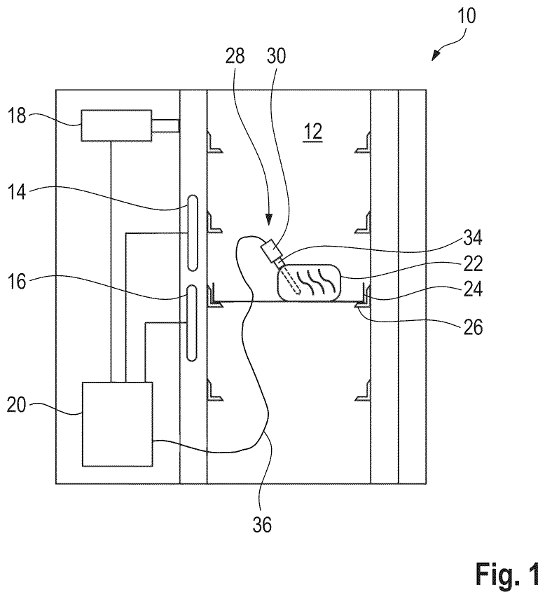

FIG. 1 schematically shows a combination cooking appliance 10 according to the invention, which has a cooking chamber 12.

In addition, a heating device 14, a steam generator 16 and a microwave generator 18 are arranged in the combination cooking appliance 10, which are each connected to a control unit 20 and driven thereby.

A cooking product 22, which is placed on a cooking product carrier 24 is placed in the cooking chamber 12. The cooking product carrier 24 can be a tray, a dish or a rack that is inserted in a slot 26 inside the cooking chamber 12.

The heating device 14 and the steam generator 16 are set up to provide a specific cooking chamber climate in the cooking chamber 12. The cooking chamber climate is specified by the control unit 20, in particular depending on a cooking program that is running. The microwave generator 18 is designed to generate electromagnetic radiation in the form of microwaves having a wavelength λ and to feed it into the cooking chamber 12. Preferably, microwaves having a frequency of 2.45 gigahertz (corresponding to a wavelength λ of 12.45 cm in a vacuum) are fed into the cooking chamber 12. The microwave radiation introduced into the cooking chamber 12 can apply (additional) energy on the cooking product 22, the cooking product 22 being thus cooked.

In addition, a core temperature detector 28 is provided in the cooking chamber 12, which is designed to monitor the core temperature of the cooking product 22 during a cooking process, provided that the core temperature detector 28 is inserted into the cooking product 22. In the case of a piece of meat such as a roast, the core temperature detector 28 can be used to determine when the roast has reached the desired degree of doneness by measuring the core temperature.

The core temperature detector 28 has a handle section 30 and a measuring section 32 adjacent to the handle section 30. The handle section 30 is designed such that a user can hold the core temperature detector 28 there.

The measuring section 32, on the other hand, fulfills the actual function of the core temperature detector 28, namely the determination of the core temperature inside the cooking product 22. To enable a core temperature sensing, the core temperature detector 28 is at least partially inserted into the cooking product 22. The core temperature detector 28 can be inserted into the cooking product 22 over the entire length of the measuring section 32, as shown in FIG. 1, or only partially, in particular in the case of small or less voluminous cooking products 22.

Furthermore, the core temperature detector 28 has a microwave trap 34, which is arranged at the transition between the measuring section 32 and the handle section 30. When inserted, the microwave trap 34 is therefore located outside the cooking product 22 or at most rests against it with its front side.

The microwave trap 34 is designed to protect the core temperature detector 28 from the energy of the microwaves when the microwave operation of the combination cooking appliance 10 is switched on, i.e. when microwaves are fed into the cooking chamber 12.

To achieve a trapping effect, the microwave trap 34 is designed as a quarter-wave trap that is tuned to the wavelength of the electromagnetic radiation used in the cooking chamber 12. For this purpose, the microwave trap 34 has a geometric length (trap depth) which corresponds to the electrical length of approximately a quarter of the wavelength of the electromagnetic radiation used in the cooking appliance 10.

The core temperature detector 28 is connected in a signal-transmitting manner to the control unit 20 by a cable 36. In this way, the core temperature detector 28 can forward the measured core temperature to the control unit 20 so that the latter can monitor the cooking process and, if necessary, regulate the cooking process taking the measured core temperature into account.

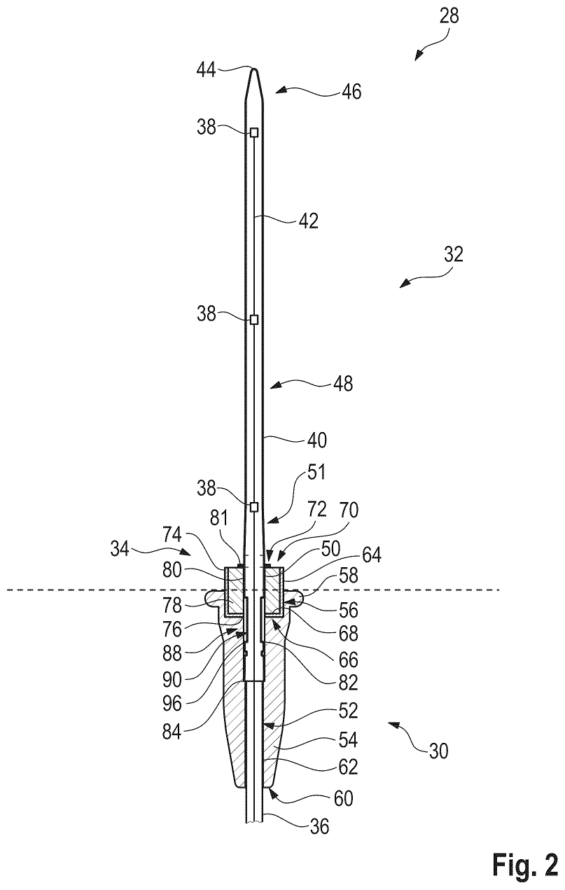

Further features of the core temperature detector 28 are explained in more detail in FIG. 2, to which reference is made below.

In FIG. 2, the core temperature detector 28 is divided into two sections, which are separated from each other by a dashed line in the drawing. The area above the dashed line in FIG. 2 is the measuring section 32, which is at least partially inserted into the cooking product 22 to measure the temperature inside the cooking product 22. Below the dashed line is the handle section 30, which is used to handle the core temperature detector 28. The microwave trap 34 is provided at the level of the dashed line and thus between the measuring section 32 and the handle section 30, i.e. in the transition.

For temperature detection, several temperature sensors 38 are provided along the measuring section 32, in the present case three temperature sensors 38. Of course, any other number of temperature sensors is conceivable. Preferably, the temperature sensors 38 are provided uniformly along the measuring section 32. At least one further temperature sensor 38 can also be provided in the handle section 30, which can act as a reference measurement for the cooking chamber temperature or as part of a microwave load sensor.

The temperature sensors 38 are surrounded by a measuring rod 40, which in the embodiment shown is configured as a hollow cylinder. In addition, a line 42 is provided in the measuring rod 40, which extends along the measuring section 32 and connects the temperature sensors 38 to each other. Starting from the temperature sensors 38, the line 42 extends into the handle section 30 and forms the signal-transmitting component of the cable 36. The core temperature values detected by the temperature sensors 38 can thus be forwarded to the control unit 20.

To allow the metallic measuring rod 40 to be inserted into the cooking product 22, the measuring rod 40 is provided at its free end facing away from the handle section 30 with a tip 44, which is adjoined by an end section 46 that widens conically in the direction of the handle section 30 and opens into a straight shaft section 48.

A closer look reveals that the shaft section 48 houses the line 42 and the temperature sensors 38.

In addition, a contacting tube 50 is provided, which can be formed in one piece with the measuring rod 40 or can be present separately therefrom and attached to the measuring rod 40. For example, the measuring rod 40 can be welded, in particular laser-welded to the contacting tube 50.

As can be seen in FIG. 2, the contacting tube 50 has a larger diameter than the measuring rod 40, so that a transition section 51 is provided, in which the measuring rod 40 widens conically in the direction of the handle section 30 until the diameter corresponds to that of the contacting tube 50. The transition section 51 can be designed in one piece together with the measuring rod 40 and/or the contacting tube 50 or can be separate from these and welded, in particular laser-welded to both.

The contacting tube 50 extends at least partially into the handle section 30 and has an handle-side end 52 which faces the handle section 30.

As shown in FIG. 2, the handle-side end 52 ends approximately halfway up the handle section 30.

In addition, the cable 36 which extends into the handle-side end 52 and runs in the direction of the measuring section 32 is guided in the contacting tube 50.

The handle section 30 is explained in more detail below.

In the handle section 30 of the core temperature detector 28, a handle 54 is provided, which is made, for example, of a plastic, preferably a heat-resistant plastic, in particular PEEK. The handle 54 has an elongated cylindrical shape in the direction of the measuring section 32, the handle 54 having one end facing the measuring section 32 and a second end facing away therefrom.

At its end facing the measuring section 32, the handle 54 is provided with a trap-side opening 56 which at least partially surrounds the microwave trap 34. Preferably, the handle 54 is injection molded around the microwave trap 34 so that the microwave trap 34 is firmly connected to the handle 54 in the area of the trap-side opening 56.

In addition, the handle 54 has a knob 58 in the area around the trap-side opening 56, which is formed as a continuous radial projection which completely surrounds the microwave trap 34. The knob 58 is used to safely handle the core temperature detector 28 without a user slipping off the handle 54.

At the end facing away from the measuring section 32, which is opposite the trap-side opening 52, the handle 54 has a cable-side opening 60. A cable duct 62 which receives the cable 36 extends from the cable-side opening 60 to the trap-side opening 56. Consequently, the handle 54 can be designed as a hollow cylinder. The handle-side end 52 of the contacting tube 50 is located at half height of the cable duct 62, which corresponds approximately to half height of the handle 54.

As already shown in FIG. 1, the microwave trap 34 is provided at the transition between the handle section 30 and the measuring section 32 adjacent thereto, which will be discussed in more detail below.

FIG. 2 shows that the microwave trap 34 comprises a cylindrical trap section 64, which is designed in a pot-shaped manner, so that the trap section 64 has a bottom 68 at a first end 66, which faces the handle section 30, and a trap opening 72 at a second end 70, which faces the measuring section 32. The two ends 66, 70 are opposite each other. Therefore, the bottom 68 is associated with the handle section 30 and the trap opening 72 is associated with the measuring section 32. The trap opening 72 is surrounded by an edge region 74.

In addition, the trap section 64 surrounds the contacting tube 40, which extends from the measuring section 32 to the handle section 30 through a passage 76 in the bottom 68 of the trap section 64. The trap section 64 is then in contact with the contacting tube 40 at the passage 76. In particular, the trap section 64 is laser-welded to the contacting tube 40 at the passage 76. In other words, the bottom 68 is configured so as to be closed up to the contacting tube 40.

Furthermore, the microwave trap 34 has a dielectric filling element 78, which is arranged in the trap section 64. More specifically, the dielectric filling element 78 is arranged between the contacting tube 40 and the trap section 64.

The filling element 78 contacts, for example via an end face, the bottom 68 of the trap section 64 and, along its outer circumference, an inner side of the trap section 64.

For example, the dielectric filling element 78 may be a ceramic having a dielectric constant of 9 to 10 (at 20° C. and 1 GHZ), in particular an aluminum oxide ceramic having a purity of at least 95%.

To allow the routing of the contacting tube 40 from the measuring section 32 into the handle section 30, the dielectric filling element 78 is shaped as a hollow cylinder having a through opening 80 which is aligned with the passage 76 in the bottom 68, such that the contacting tube 40 extends at least partially through the passage 76 and the through opening 80.

As can be clearly seen in FIG. 2, the contacting tube 40 in the embodiment shown extends completely through the through opening 80 through the filling element 78. In this respect, the contacting tube 40 also extends completely through the trap section 64. This results in the filling element 78, the contacting tube 40 and the trap section 64 being arranged coaxially with respect to each other.

Furthermore, an annular end element 81 is provided in the area around the trap opening 72 of the trap section 64, which rests on the end face 83 of the filler element 78 and completely encloses the circumference of the contacting tube 40, the annular end element 81 being fastened, in particular laser-welded to the contacting tube 40. The ring-shaped end element 81 serves to hold the dielectric filling element 78 in the microwave trap 34 in a captive manner.

The ring-shaped end element 81 is preferably made of an electrically conductive material. The ring-shaped end element 81 is particularly preferably made of a metal or an alloy.

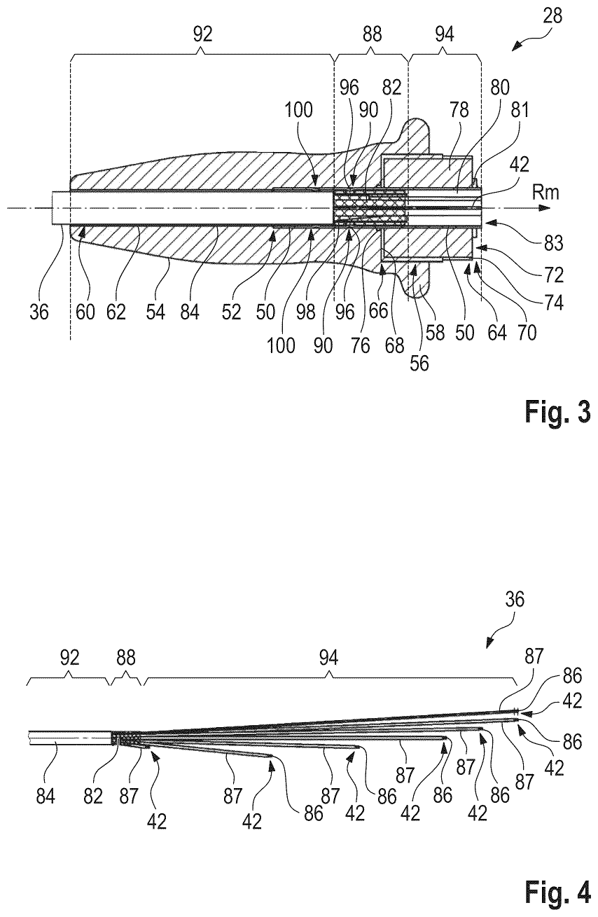

The microwave trap 34 is designed to prevent excessive heating of the handle 54 and thus of the entire core temperature detector 28. To achieve this, the contacting tube 50 is contacted with the cable 36 in a certain way, which is explained below with reference to FIGS. 3-6.

First, the structure of the cable is described in more detail on the basis of FIG. 4.

The cable 36 comprises at least the line 42, which is enveloped by a shielding 82. The latter is in turn surrounded by a line sheath 84.

The shielding 82 serves to protect the interior of the cable 36, i.e. the at least one line 42, from electromagnetic interference.

The shielding 82 may be a braided shielding, as shown in FIG. 3. For example, the braided shielding is designed as copper wires which are braided around the at least one line 42. The wires are either bare or tin-plated. In any case, the shielding 82 is made of an electrically conductive material.

The at least one line 42 is preferably made of a copper wire 86 and insulated with a further envelope 87. In this way, the line 42 can be insulated from the shielding 82 and from optionally further lines 42. As shown in FIG. 4, the cable 36 preferably comprises six lines 42.

Alternatively, the shielding 82 can also be a foil. The outer line sheath 84 serves to protect the inside of the cable from moisture and other liquids from the cooking chamber 12. It can be made of PTFE.

The outer line sheath 84 can be made of polytetrafluoroethylene (PTFE) and have a wall thickness greater than 0.3 mm, for example in the range of 0.35 mm to 1 mm, preferably from 0.45 mm to 0.7 mm. This represents a significant reinforcement of the outer PTFE line sheath 84 compared to conventional sheathing, the wall thickness of which is usually less than 0.1 mm, in particular in the range of 0.01 mm to 0.05 mm. This allows the temperature inside the cable 36 to be kept low during microwave operation of the combination cooking appliance 10, so that the individual lines 42 do not overheat. The lines 42 are better shielded due to the outer line sheath 84 having the appropriate wall thickness.

Finally, the outer line sheath 84 with its wall thickness ensures that the distance between the shielding 82, which is (directly) surrounded by the outer line sheath 84, and a metal of the cooking chamber 12, e.g. a cooking chamber wall, is sufficiently large. The outer line sheath 84 thus also provides (electromagnetic) shielding for the lines 42 due to its wall thickness, in particular in addition to the shielding 82. Due to the wall thickness of the outer line sheath 84, it is in particular ensured that the lines 42 are optimally positioned in the electric field present in the cooking chamber 12.

The cable 36 is secured in the handle section 30 in a captive manner by the cable 36 being attached to the contacting tube 50. For this purpose, the cable 36 in the handle section 30 has a unsheathed area 88. In this unsheathed area 88, the contacting tube 50 forms a contact point 90 along with the cable 36.

The unsheathed area 88 is characterized by the fact that this section of the cable 36 is stripped, i.e. freed from the outer line sheath 84, so that the part below of the cable 36, i.e. the shielding 82, is exposed to the outside. This allows the contacting tube 50 to contact the shielding 82 via the contact point 90. The unsheathed area 88 is provided in the handle section 30 and extends in the direction of the measuring section 32 into the microwave trap 34.

In principle, the section of the shielding 82 which is not surrounded by the outer line sheath 84 defines the spatial extent of the unsheathed area 88. The latter extends into the microwave trap 34.

Adjacent to the unsheathed area 88, an insulated area 92 of the cable 36 is provided in the direction of the handle section 30, the shielding 82 being not freed from the line sheath 84 in the insulated area 92, and the handle-side end 52 of the contacting tube 50 being arranged therein. Consequently, the handle-side end 52 rests on the outer line sheath 84. The handle-side end 52 of the contacting tube 50 is in particular crimped onto the outer line sheath 84, a firm connection between the cable 36 and the contacting tube 50 being thus achieved. The insulated area 92 extends out of the handle 54 into the control unit 20.

Adjacent to the unsheathed area 88 in the direction of the measuring section 32, a shielding-free area 94 is provided, in which the cable 36 is freed from the shielding 82, so that only the lines 42 extend into the measuring rod 40. In this respect, the unsheathed area 88 is arranged between the insulated area 92 and the shielding-free section 94. Preferably, the shielding 82 ends before the measuring rod 40. Particularly preferably, the shielding 82 ends within the microwave trap 34.

The contact point 90 is explained in more detail below.

More specifically, the contacting tube 50 contacts the shielding 82 of the cable 36 in an electrically conductive manner at the contact point 90, so that currents can flow between the shielding 82 and the contacting tube 50, for example currents which are generated due to the influence of microwave radiation on the measuring rod 40, the trap section 64 and the contacting tube 50.

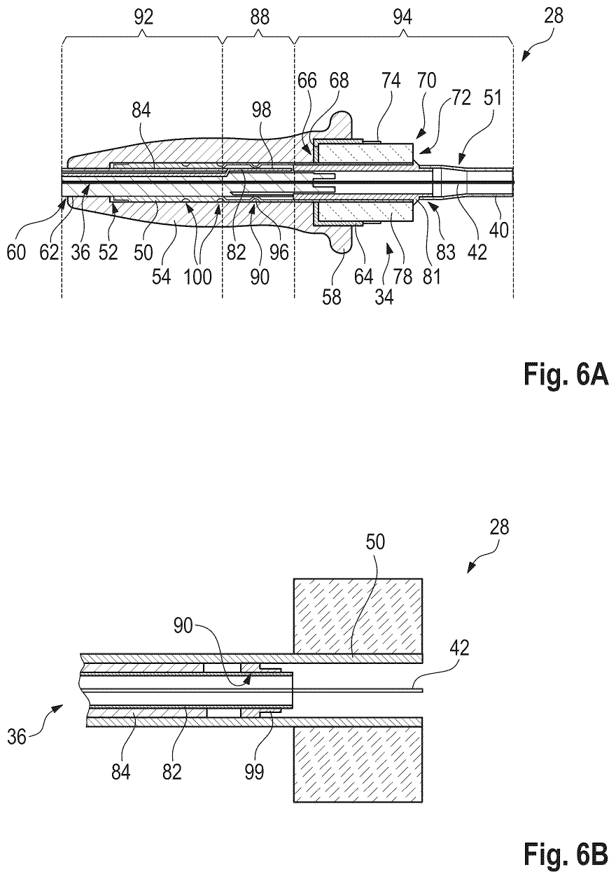

The contact point 90 can be formed by a radially inwardly directed bulge 96 of the contacting tube 50, the bulge 96 being in particular produced by rolling the contacting tube 50 onto the cable 36. This is particularly visible in FIG. 6.

Rolling is a process in which the contacting tube 50 is first pushed onto the shielding 82 and then at least partially deformed by a radially inwardly directed force, so that the bulge 96 is formed on the circumference of the contacting tube 50, which contacts the shielding 82. In this respect, the contacting tube 50 is crimped onto the shielding 82 by means of the contact point 90, so that they are captively connected to each other.

In addition, the contacting tube 50 can substantially completely touch the shielding 82 at the contact point 90 along the circumference of the shielding 82, so that the contact point 90 is formed as a continuous contact ring.

The contact ring can be formed by a continuously formed bulge 96 that completely surrounds the circumference of the shielding 82.

As shown in FIGS. 3 and 6A, a counterpressure element 98 can also be provided which is designed to exert a radially outwardly directed force on the shielding 82 so that it is pressed outwardly against the contacting tube 50. In this way, the shielding 82, which is in any case configured to be mechanically flexible, can be tensioned outwardly to achieve a better electrical contact between the shielding 82 and the contacting tube 50.

The counterpressure element 98 can be a metallic sleeve which is pushed onto the lines 42 in the unsheathed area 88, so that the shielding 82 lying over the lines 42 is pushed radially outwards. FIG. 6A shows that the lines 42 make a kink outwards in the direction of the shielding 82 due to the counterpressure element 98.

Alternatively, as shown in FIG. 6B, a pressure element 99 is provided, which is formed as a metallic sleeve. The latter is pushed onto the line 42 in the unsheathed area 88, so that the shielding 82 lies within the pressure element 99 formed as a sleeve and is in particular completely surrounded by it on the circumference. The sleeve is connected in an electrically conductive manner to the shielding 82, in particular crimped thereto.

In addition, the sleeve has a portion via which the sleeve is connected to the contacting tube 50 (mechanically and/or electrically), in particular rolled. The portion thus provides outward counterpressure for the rolling onto the contacting tube 50, which is why the pressure element 99 acts as a counterpressure element for the contacting tube 50. For this purpose, the portion can have a larger diameter than the rest of the sleeve.

In this respect, the sleeve is used to form the (indirect) contact point 90, which connects the shielding 82 and the contacting tube 50 to each other, in particular in an electrically conductive manner.

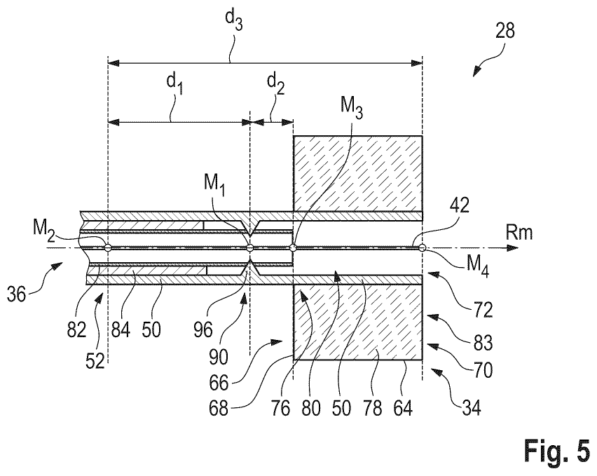

However, the counterpressure element 98 or the pressure element 99 can also be omitted. One embodiment without the counterpressure element 98 or the pressure element 99 is shown, for example, in FIG. 5.

In any case, the direct or indirect contact point 90 is formed in the unsheathed area 88, via which the contacting tube 50 is directly or indirectly (at least) electrically connected to the cable 36.

As shown in FIGS. 3 and 6A, 6B, the contacting tube 50 can not only be in contact with the shielding 82 via a contact point 90, but the contacting tube 50 can also be crimped in the insulated section 92 by at least one recess 100 on the line sheath 84. As a result, the contacting tube 50 is particularly firmly connected to the cable 36 and, furthermore, the penetration of moisture via the cable-side opening 60 of the handle 54 is prevented.

The recess 100 can also be designed as an inwardly directed bulge 96, which is pressed against the line sheath 84 at least with its vertex. A continuous recess surrounding the circumference of the cable 36 is also conceivable and preferred.

To keep the heat input into the handle 54 as low as possible, a certain distance d₁ is to be selected between the handle-side end 52 of the contacting tube 50 and the contact point 90.

The distance d₁ from the contact point 90 to the handle-side end 52 corresponds to an electrical length of the microwave radiation in the handle section 30, which is shorter than or equal to a quarter of the wavelength of the microwave radiation used in the combination cooking appliance 10. The distance d₁ is measured from the centers M₁ of the contact point 90 to the center M₂ of the handle-side end 52, with both centers lying on the same axis of rotation Rₘ.

The contact point 90 is particularly preferably arranged at a minimum distance d₂ from the bottom 68. The distance d₂ can be in a range from 0.1 to 4 mm. The distance d2 is measured from the center points M1 of the contact point 90 to the center point M3 of the bottom 68, both center points lying on the same center axis of rotation Rm.

Furthermore, the trap opening 72 may have a distance d₃ to the handle-side end 52, which corresponds to an electrical length of the microwave radiation in the handle section 30 which is shorter than or equal to one quarter of the wavelength of the microwave radiation used in the combination cooking appliance 10. The distance d₃ is measured from the centers M₂ of the handle-side end 52 to the center M₄ of the trap opening 72, both centers lying on the same axis of rotation Rₘ.

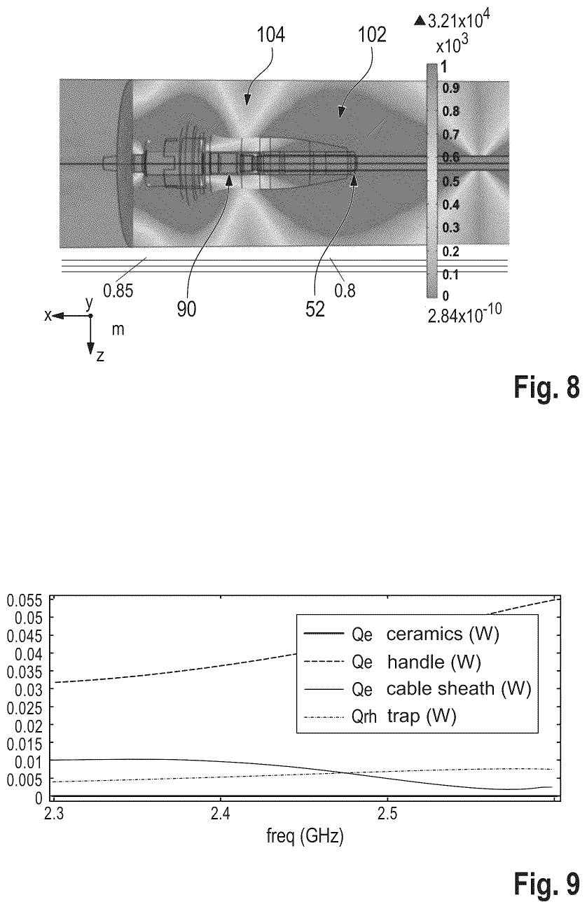

The reduced heat transfer achieved by the position of the contact point 90 is based on the findings obtained from the simulation of the E-field, as shown in FIGS. 8, 9 and 10.

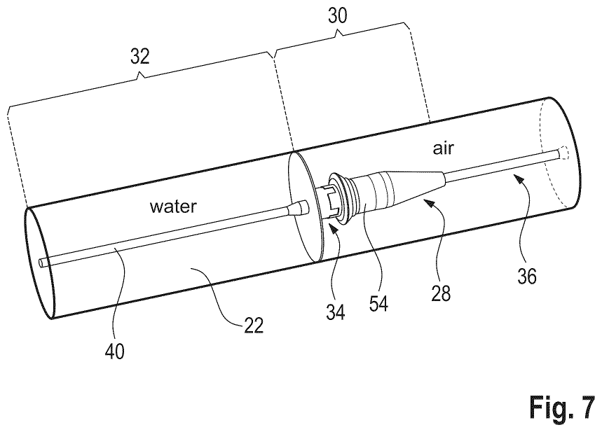

The simulation model is shown in FIG. 7. In this model, the core temperature detector 28 can be seen, which is completely inserted with its measuring rod 40 into a simulated cooking product, in this case a water medium as a cooking product substitute. The microwave radiation is fed in from the right as a coaxial mode between the cable 36 and the outer boundary layer (PEC for the simulation). At the bottom left is a port (at the bottom of the water) which absorbs the outgoing waves. Based on this simulation, the power loss density in the handle 54 and the electric field strength or surface currents can be calculated.

FIG. 8 shows a cross-section along a core temperature detector 28 not according to the invention, in which the handle-side end 52 has a distance d which corresponds to an electrical length of the microwave radiation in the handle section 30, which is greater than a quarter of the wavelength of the microwave radiation used in the combination cooking appliance 10. The E-field reflected at the water on the left, similar to the cooking product 22, is shown. The intensity of the E-field is shown on the basis of a scale in V/m (based on the 1W excitation), with lighter areas 102 corresponding to a high E-field and darker areas 104 corresponding to a lower E-field.

The simulation in FIG. 8 shows that the handle-side end 52 is located in a maximum of the E-field. This is disadvantageous and leads to higher currents along the contacting tube 50 and the handle 54, as a result of which the latter experiences a particularly strong energy input from the E-field.

This is also shown in the graph in FIG. 9, which displays the data collected from the simulation of FIG. 9. It can be seen that the handle 54 (upper line in the diagram) experiences a particularly strong energy input compared to the other components.

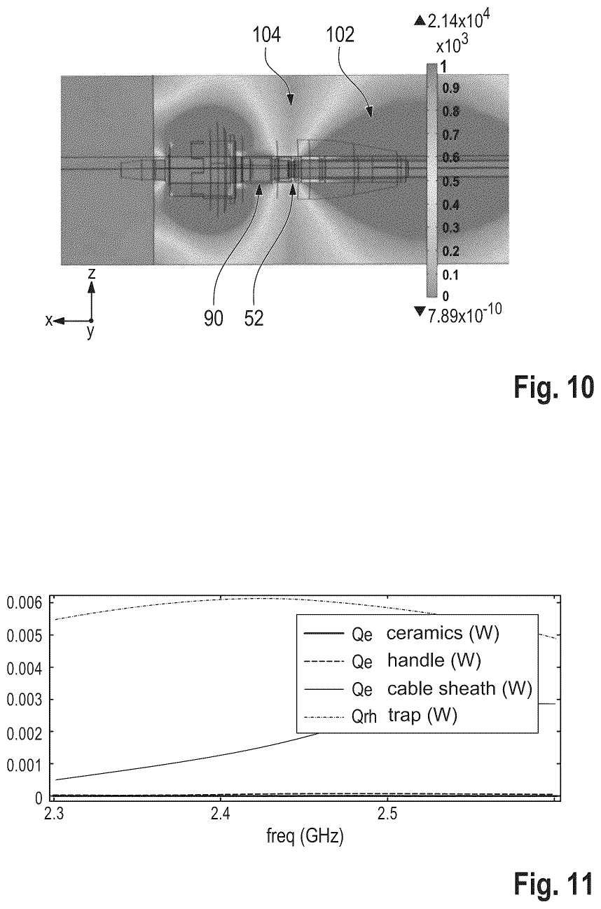

FIG. 10 shows the same simulation as FIG. 8, with the difference that the handle-side end has a distance d₁ corresponding to an electrical length of the microwave radiation in the handle section 30, which is less than one quarter of the wavelength of the microwave radiation used in the combination cooking appliance 10. As a result, the handle-side end 52 is located in a minimum of the E-field.

The handle 54 therefore experiences less energy input compared to the arrangement of the handle 54 in FIG. 9. As a result, the handle 54 heats up less.

This is also shown in FIG. 11, in which the handle 54 has the lowest energy input compared to the other components, and which is also lower by one order of magnitude compared to FIG. 9.

1. A core temperature detector for a combination cooking appliance for cooking a cooking product, comprising a measuring section and a handle section,
wherein a contacting tube is provided which extends at least partially into the handle section and has a handle-side end facing the handle section, wherein a cable extending from the handle section into the measuring section is guided in the contacting tube,
wherein the cable has an unsheathed area in the handle section, in which the contacting tube forms a contact point along with the cable, wherein the contact point has a distance d₁ to the handle-side end, which corresponds to an electrical length of the microwave radiation in the handle section, which is shorter than or equal to one quarter of the wavelength of the microwave radiation used in the combination cooking appliance.

2. The core temperature detector according to claim 1, wherein the core temperature detector has a microwave trap which includes a pot-shaped trap section having a trap opening aligned with the measuring section and a bottom provided with a central passage in the direction of the handle section, wherein the contacting tube extends through the central passage, in particular wherein the contacting tube is in contact with the bottom at the central passage, more preferably in that the contacting tube is laser-welded to the bottom at the central passage.

3. The core temperature detector according to claim 1, wherein the contacting tube contacts a shielding of the cable in an electrically conductive manner at the contact point, wherein the shielding is in particular a braided shielding.

4. The core temperature detector according to claim 3, wherein the handle-side end of the contacting tube is arranged in an insulated area of the cable, in which the shielding is surrounded by an outer line sheath.

5. The core temperature detector according to claim 3, wherein a counterpressure element is arranged in the unsheathed area below the shielding and is designed to exert a radially outwardly directed force on the shielding, so that the latter is pressed outwardly against the contacting tube, or
wherein a pressure element is arranged in the unsheathed area above the shielding, which forms the contact point connecting the shielding to the contacting tube.

6. The core temperature detector according to claim 3, wherein the contacting tube substantially completely touches the shielding or the pressure element at the contact point along the circumference of the shielding or of the pressure element so that the contact point is formed as a continuous contact ring.

7. The core temperature detector according to claim 1, wherein the contact point is formed by a radially inwardly directed bulge of the contacting tube, wherein the bulge is produced in particular by rolling the contacting tube onto the cable.

8. The core temperature detector according to claim 2, wherein the contact point is arranged at a minimum distance d₂ from the bottom.

9. The core temperature detector according to claim 2, wherein the trap opening has a distance d₃ to the handle-side end which corresponds to an electrical length of the microwave radiation in the handle section, which is shorter than or equal to one quarter of the wavelength of the microwave radiation used in the combination cooking appliance.

10. A combination cooking appliance for cooking a cooking product, comprising a cooking chamber, a microwave generator and a control unit which is in communication with a core temperature detector as claimed in claim 1 which is provided in the cooking chamber.

11. The core temperature detector according to claim 2, wherein the contacting tube contacts a shielding of the cable in an electrically conductive manner at the contact point, wherein the shielding is in particular a braided shielding.

12. The core temperature detector according to claim 11, wherein the handle-side end of the contacting tube is arranged in an insulated area of the cable, in which the shielding is surrounded by an outer line sheath.

13. The core temperature detector according to claim 4, wherein a counterpressure element is arranged in the unsheathed area below the shielding and is designed to exert a radially outwardly directed force on the shielding, so that the latter is pressed outwardly against the contacting tube, or
wherein a pressure element is arranged in the unsheathed area above the shielding, which forms the contact point connecting the shielding to the contacting tube.

14. The core temperature detector according to claim 4, wherein the contacting tube substantially completely touches the shielding or the pressure element at the contact point along the circumference of the shielding or of the pressure element so that the contact point is formed as a continuous contact ring.

15. The core temperature detector according to claim 5, wherein the contacting tube substantially completely touches the shielding or the pressure element at the contact point along the circumference of the shielding or of the pressure element so that the contact point is formed as a continuous contact ring.

16. The core temperature detector according to claim 11, wherein a counterpressure element is arranged in the unsheathed area below the shielding and is designed to exert a radially outwardly directed force on the shielding, so that the latter is pressed outwardly against the contacting tube, or
wherein a pressure element is arranged in the unsheathed area above the shielding, which forms the contact point connecting the shielding to the contacting tube.

17. The core temperature detector according to claim 12, wherein a counterpressure element is arranged in the unsheathed area below the shielding and is designed to exert a radially outwardly directed force on the shielding, so that the latter is pressed outwardly against the contacting tube, or
wherein a pressure element is arranged in the unsheathed area above the shielding, which forms the contact point connecting the shielding to the contacting tube.

18. The core temperature detector according to claim 12, wherein the contacting tube substantially completely touches the shielding or the pressure element at the contact point along the circumference of the shielding or of the pressure element so that the contact point is formed as a continuous contact ring.
